(19) United States
(12) Patent Application Publication
(10) Pub. No.: US 2004/0267380 A1
(43) Pub. Date: Dec. 30, 2004

(54) Programmable logic controller with an extra memory

(76) Inventor: Tsang-Yi Lin, Taoyuan (TW)

Correspondence Address: BIRCH STEWART KOLASCH & BIRCH, PO BOX 747, FALLS CHURCH, VA, 22040-0747, US

(21) Appl. No.: 10/661,680

(22) Filed: Sep. 15, 2003

(30) Foreign Application Priority Data
Jun. 13, 2003 (TW) 092116105

(51) Int. Cl. G06F 13/00

(52) U.S. Cl. 700/1

(57) ABSTRACT

A programmable logic controller connects to an extra memory by a data bus. The memory of the PLC stores an indicating instruction. As the CPU of the PLC reads the indicating instruction, then the CPU reads the address of the extra memory to execute the data codes stored in the extra memory. Thus the programmable logic controller with an extra memory updates or expands the data codes in the extra memory effectively without changing the memory inside the PLC.

### BACKGROUND OF THE INVENTION

1. Field of Invention

The invention relates to a programmable logic controller with an extra memory used in automated apparatus, in particular, the PLC stores more data codes in the extra memory.

2. Related Art

Programmable logic controllers (PLCs) are powerful tools for process control. Nowadays, operations of automated processes in factories are mostly performed by programmable logic controllers. Basically, a PLC is a small computer specially designed for the system that controls these processes. Users may write programs into the memory module through software, a writing device, and a human-computer interface provided by original factories. The central processing unit (CPU) of the PLC monitors and processes input signals from button keys, sensors or limit switches according to the control logic defined in the programs. After a logic determination, output signals are sent to outer loads such as relays, indicating lights, electromechanical apparatus, or the like. On some occasions, and depending on the requirements of the production line, the output signals may be fed back to become input signals and control other output facilities.

Generally, the PLC has at least a CPU and a memory, the memory stores a plurality of data codes for the CPU to execute several kinds of motions controlling apparatus. However, users can not rewrite the data codes stored in the memory. Once some of the data codes are unexpected or wrong, users have to send the PLC to the original factories to change the memory. This way of reparation is inconvenient. And the quantity of the data codes stored in the memory corresponds to the volume of the memory.

### SUMMARY OF THE INVENTION

To solve the problems described above, the invention illustrates a programmable logic controller with an extra memory to provide using facility.

A programmable logic controller with an extra memory has a PLC body, a data bus, and an extra memory. The PLC body has a memory and a central process unit (CPU) inside, the memory stores a plurality of data codes and an indicating instruction, and the CPU reads the data codes stored in the memory and executes the data codes to control the connecting apparatus. The extra memory connects electrically to the CPU by a data bus. Normally, the CPU reads the data codes stored in the memory and executes the data codes to control the connecting apparatus. But after the CPU has read the indicating instruction, the CPU reads the address of the extra memory to execute the data codes stored in the extra memory. Thus the invention allows the PLC updating or expanding the data codes easily.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 is a schematic view of the invention;

FIG. 2 is a schematic view of the extra memory fabricating to the housing;

FIG. 3 is a schematic view of the movement of the housing; and

FIG. 4 is a schematic view of the housing fabricating to the PLC.

### DETAILED DESCRIPTION OF THE INVENTION

A programmable logic controller with an extra memory is shown in FIG. 1. The PLC body 40 has a memory 41 and a central process unit (CPU) 42 inside, and a PLC body 40 connects electrically to an extra memory 44 by a data bus 43. The memory 41 stores a plurality of data codes and an indicating instruction. The CPU 42 reads the data codes stored in the memory 41 and executes the data codes to control the connecting apparatus. But after the CPU 42 has read the indicating instruction, the CPU 42 reads the address of the extra memory 44 to execute the data codes stored in the extra memory. So the invention allows the data codes stored in the extra memory 44 to be rewritten and the PLC expands the quantity of data codes stored in the extra memory 44. Users can repair the PLC with an extra memory in the ways below. The providers of the PLC 40 can rewrite the data codes stored in the extra memory 44, and give the PLC body 40 back to the vendors to fabricate the extra memory 44 to the PLC body 40. Or the providers of the PLC body 40 give the data codes to the vendors, and the vendors rewrite the data codes stored in the extra memory 44 and fabricate the extra memory 44 to the PLC body 40.

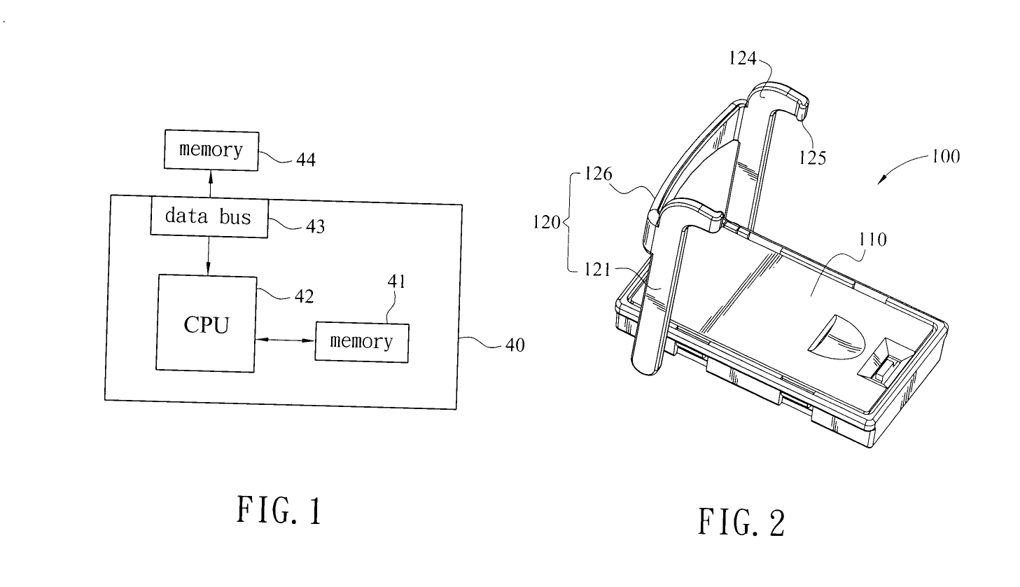

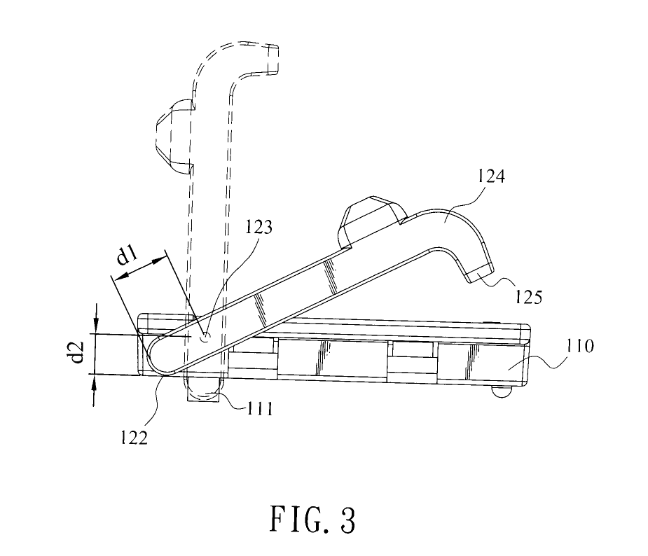

As shown in FIG. 2, the extra memory 44 is swathed by a housing 100, and the housing 100 has a body 110 and a moving member 120. The body 110 is a rectangular plate for accommodating the extra memory 44 inside, and has a connecting port 111 extending downward vertically on one side of the bottom. The moving member 120 is formed in an H-shaped composed of long plates with a little flexibility. The moving member 120 has two vertical arms 121 parallel to each other along two sides of the body 110, and a horizontal arm 126 connecting to the two vertical arms 121 crossing the top side of the body 110. One end of the vertical arm 121 has a pivotal connecting end 122 with a curvy shape, and a shaft 123 on the inner side surface of the pivotal connecting end 122 pivotally connects to two sides of the body 110. The pivotal connecting positions of the two shafts 123 are on the upper side of the two sides of the connecting port 111. The vertical distance, d1, between the shaft 123 and the end of the vertical arm 121 is greater than the vertical distance, d2, between the shaft 123 and the bottom of the body 110, as shown in FIG. 3. Another end of the vertical arm 121 is an inserting end 124 bending downward to form a hook 125.

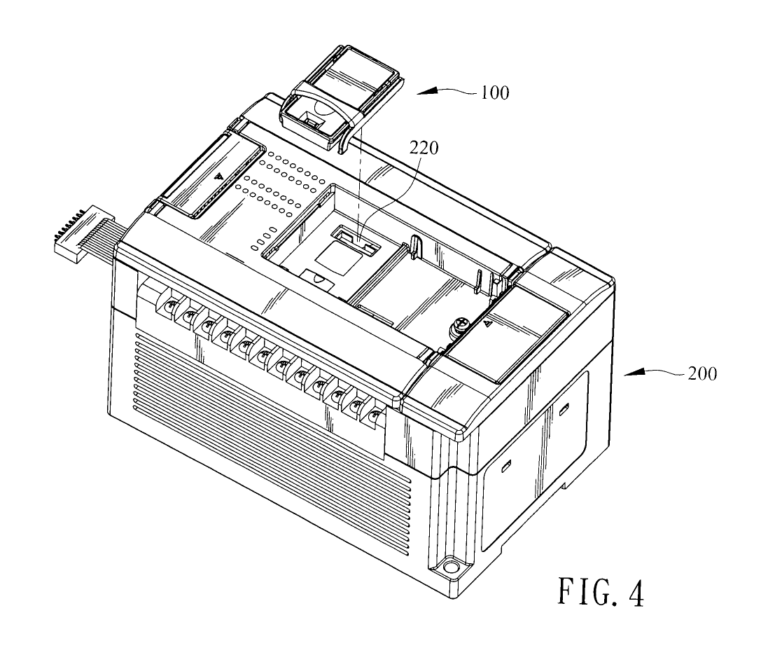

As shown in FIG. 4, the extra memory 44 connects to the PLC body 200 by inserting the connecting port 111 of the body 110 to the inserting slot 220 of the PLC body 200. When pulling out the extra memory 44, users only need to lift the horizontal arms 126 of the moving member 120. With the flexibility of the moving member 120, the hooks 125 of the two vertical arms 121 separate the PLC body 200 easily. Meanwhile, the pivotal connecting end 122 touch the surface of the PLC body 200 because d1 (the vertical distance between the shaft 123 and the end of the vertical arm 121) is greater than d2 (the vertical distance between the shaft 123 and the bottom of the body 110). And the pivotal connecting end 122 with a curvy shape helps the rotating process of the shaft 123 and helps to touch the surface of the PLC body 200 smoothly. According to the lever principle, the way described above make the connecting port 111 move upward and separate the inserting slot 220.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A programmable logic controller with an extra memory, comprising:
a PLC, comprising at least a memory storing a plurality of data codes and an indicating instruction, and a CPU for reading and executing the data codes;
a data bus, connecting electrically to the CPU; and
an extra memory, connecting to the data bus, comprising at least a data code;
wherein after the indicating instruction stored in the memory has been read, the CPU reads the address of the extra memory to execute the data code stored in the extra memory.

2. The programmable logic controller with an extra memory of claim 1, wherein the extra memory is swathed by a housing.

3. The programmable logic controller with an extra memory of claim 2, wherein the housing comprising:
a body, accommodating the extra memory inside, comprising a connecting port extending downward vertically on one side of the bottom; and
a moving member, comprising a horizontal arm and a vertical arm connecting to each other, the horizontal arm crossing the top side of the body and the vertical arm pivotally connecting to the side of the body by a pivotal connecting end.

4. The programmable logic controller with an extra memory of claim 3, wherein the vertical distance between the pivotal connecting position of the moving member and the end of the pivotal connecting end is greater than the vertical distance between the pivotal connecting position of the moving member and the bottom of the body.

5. The programmable logic controller with an extra memory of claim 3 wherein another end of the vertical arm bends downward to form a hook.

6. The programmable logic controller with an extra memory of claim 3 wherein the pivotal connecting end of the vertical arm has a shaft connecting to the side of the body.
